(19) United States
(12) Patent Application Publication
(10) Pub. No.: US 2007/0095298 A1
(43) Pub. Date: May 3, 2007

(54) Bird house

(76) Inventors: William N. Whitlock, Siesta Key, FL (US); Charles Brewer, Linn Creek, MO (US)

Correspondence Address: THORPE NORTH & WESTERN, LLP., 8180 SOUTH 700 EAST, SUITE 200, SANDY, UT, 84070, US

(21) Appl. No.: 11/591,670

(22) Filed: Oct. 31, 2006

Related U.S. Application Data
(60) Provisional application No. 60/732,184, filed on Oct. 31, 2005.

(51) Int. Cl. A01K 31/00

(52) U.S. Cl. 119/431

(57) ABSTRACT

A bird house is formed of flexible material forming a collapsible shell. A closeable opening allows access to the inside of the shell. The closable opening may be the floor, a side, or the top of the shell, and can be closed by a zipper or other type of closure device, such as hook and loop fastener material. The bird house is shaped by shaping pieces, such as flat shape retaining pieces, held in or by the collapsible shell or by a shaping frame that fits into the collapsible shell. An entrance opening provides access to the bird house by birds. The size of the access opening may be selected by the user.

### RELATED APPLICATIONS

This application claims the benefit of Provisional Application Ser. No. 60/732,185, filed Oct. 31, 2005, and entitled “Bird House”.

### BACKGROUND OF THE INVENTION

1. Field

The invention is in the field of bird houses.

2. State of the Art

Bird houses are generally made of rigid material such as wood with a floor, walls, and roof secured together into a rigid bird house. These bird houses take up space in shipping and on store shelves. Further, they are also relatively heavy. U.S. Pat. No. 6,024,051 shows a collapsible fabric bird house which is shaped when assembled for use by resilient rods inserted into sleeves forming edges of the bird house in a manner similar to tents. The bird house also has a floor in the form of a flap which can be opened along three sides to hang down for cleaning.

In attracting birds, often the size of the opening for the bird into the house will determine the kind of birds attracted to the house. However, the size of the opening is designed into the house and is not generally selectable or adjustable by the user. U.S. Pat. No. 6,827,037 discloses a bird house preferably made of a length of PVC tubing having an entrance opening therethrough of a first size. A constrictor plate with at least one opening of a second, smaller size is slidably secured inside the bird house positioned so that it can be slid into position and secured by a user with the second size opening in the first size opening to thereby selectively reduce the size of the entrance opening. This bird house has a removable bottom for cleaning.

### SUMMARY OF THE INVENTION

According to the invention, a bird house includes flexible material forming a collapsible shell that is collapsed for transportation and storage. Shaping means which are easily stored and shipped are used to provide shape to the shell for use. The shaping means may be a plurality of flat pieces which are inserted into holding means such as receiving pockets in the shell to form the walls and floor of the bird house.

In another embodiment the shaping means may be a light-weight frame assembly of lengths of material such as PVC pipe connected by pipe connectors which is inserted into the shell to shape it.

The opening for entrance of a bird may be made adjustable so that the user, when assembling the house, uses an opening of desired size. A portion of a wall of the shell can be made of transparent material and a flap provided so a user can raise the flap to look into the house.

The shell also has a closeable opening, preferably around a portion of the floor, to provide access to the inside of the shell for insertion of the shaping means and for cleaning the bird house.

### THE DRAWINGS

The best mode presently contemplated for carrying out the invention is illustrated in the accompany drawings, in which:

FIG. 1 is a pictorial view of one embodiment of a bird house of the invention;

FIG. 2 is a pictorial assembly view of the bird house of FIG. 1, with the bird house shown upsidedown from the orientation shown in FIG. 1 and with the bottom open (at the top in FIG. 2) so that the inside of the bird house is visible;

FIG. 3 is a vertical section taken on the line 3-3 of FIG. 1;

FIG. 4 is a pictorial assembly view of a second embodiment of bird house of the invention, shown similarly to FIG. 2 in upsidedown orientation with the bottom open to show the inside of the bird house;

FIGS. 5-7 are perspective views of alternate front wall shaping pieces with different size openings; and

FIGS. 8-11 are perspective views of alternate entrance opening forming inserts with different size openings.

### DETAILED DESCRIPTION OF THE ILLUSTRATED EMBODIMENTS

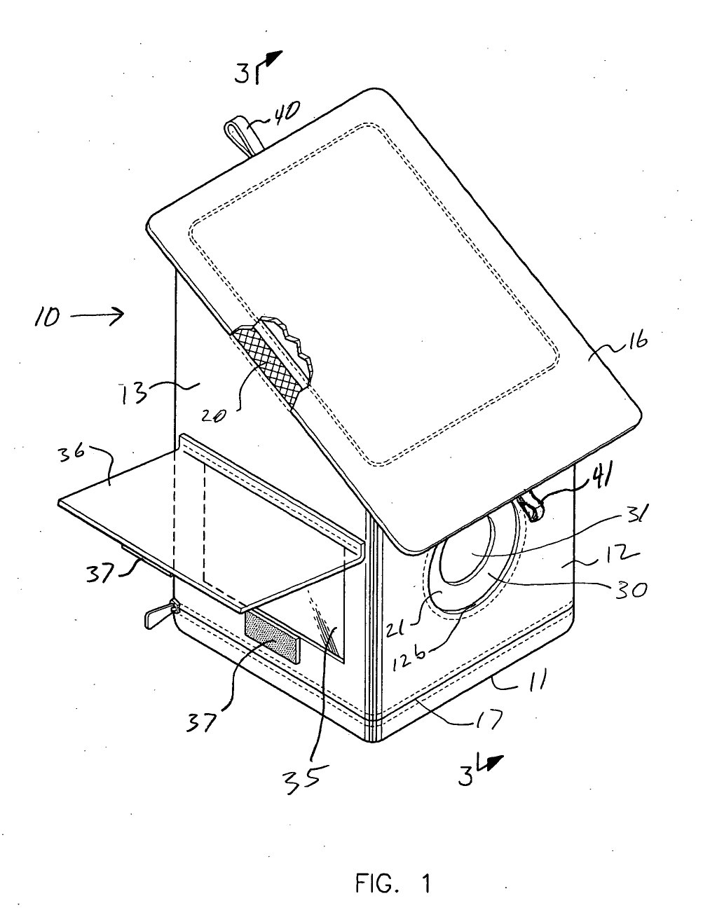

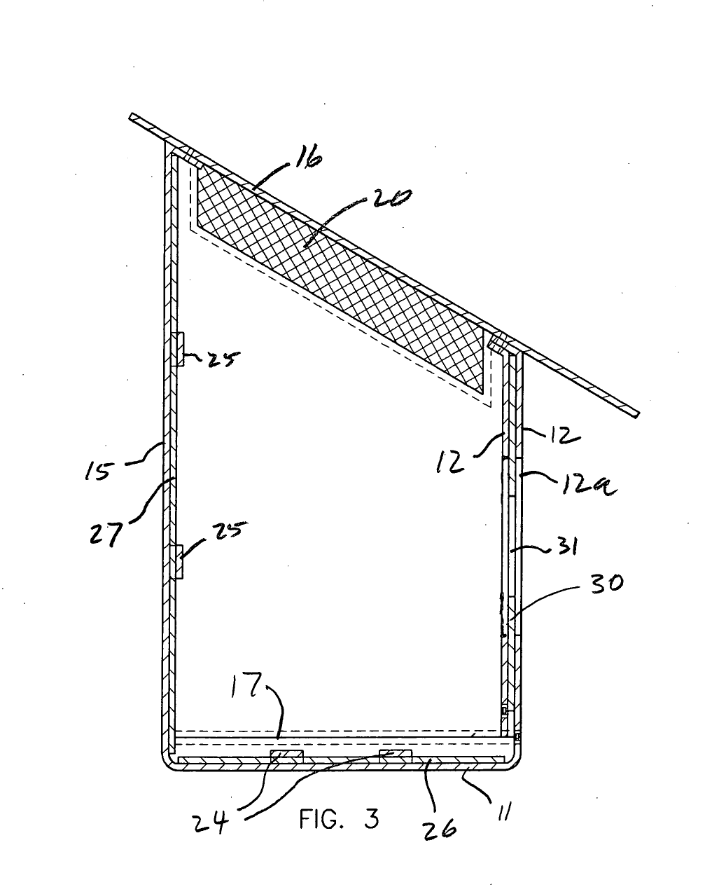

The bird house 10 of the invention, as illustrated in FIGS. 1-3, includes a flexible shell which forms a floor 11, front wall 12, side walls 13 and 14, back wall 15, and roof 16 of the bird house. This shell is made of a fabric or other flexible material, such as a water resistant and UV resistant nylon, so that it is completely collapsible. A closable opening, here shown as the floor, allows access to inside the shell. The floor is in the form of a flap extending from the back wall 15 and closably secured by closure means, here shown as zipper 17, to the bottom of the side walls 13 and 14 and front wall 12. With zipper 17 unzipped, the inside of the bird house is completely accessible to a user and the inside surface of floor 11 is accessible for cleaning. In fact, the whole bird house shell is easily washed. Mesh or netting material 20 at the top of the side walls 13 and 14 provides ventilation for the bird house. An entrance opening 21 in front wall 12 provides an entrance for birds into the bird house. Rather than the floor being openable along zipper 17 as shown to provide the closable opening to provide access into the bird house, the closable opening providing access into the bird house can be provided by a wall or portion of a wall that opens, or by the roof or a portion of the roof that opens.

The collapsible shell requires shaping means to provide structural shape to the shell and maintain its shape during use as a bird house. In the embodiment shown in FIGS. 1-3, floor 11 includes holding straps 24 and back wall 15 includes holding straps 25. A flat floor shaping piece 26 is inserted between the inside surface of floor 11 and holding straps 24. A back wall shaping piece 27 is inserted between the inside surface of back wall 15 and holding straps 25. Front wall 12 is made of two layers of material 12a and 12b with closure means, such as zipper 28, to form a pocket. A flat front wall shaping piece 30, having an entrance opening 31 therethrough, is inserted into the front wall pocket with its entrance opening 31 aligned with the front wall entrance opening 21. Zipper 28 is closed to securely locate front wall shaping piece 30 with respect to front wall 12.

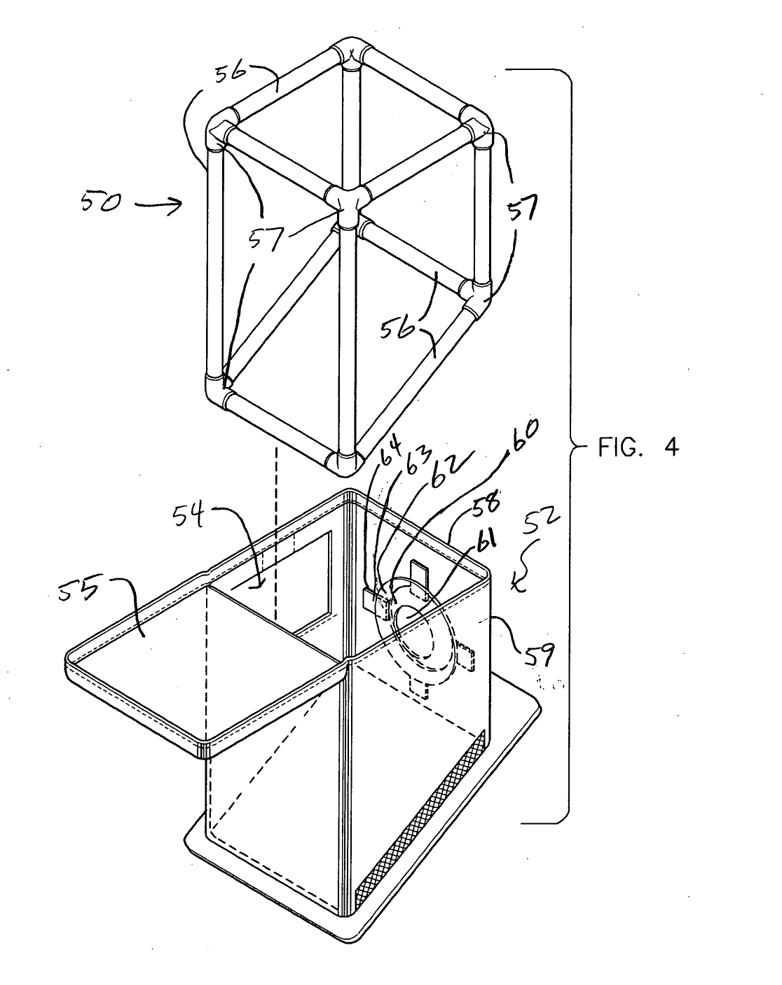

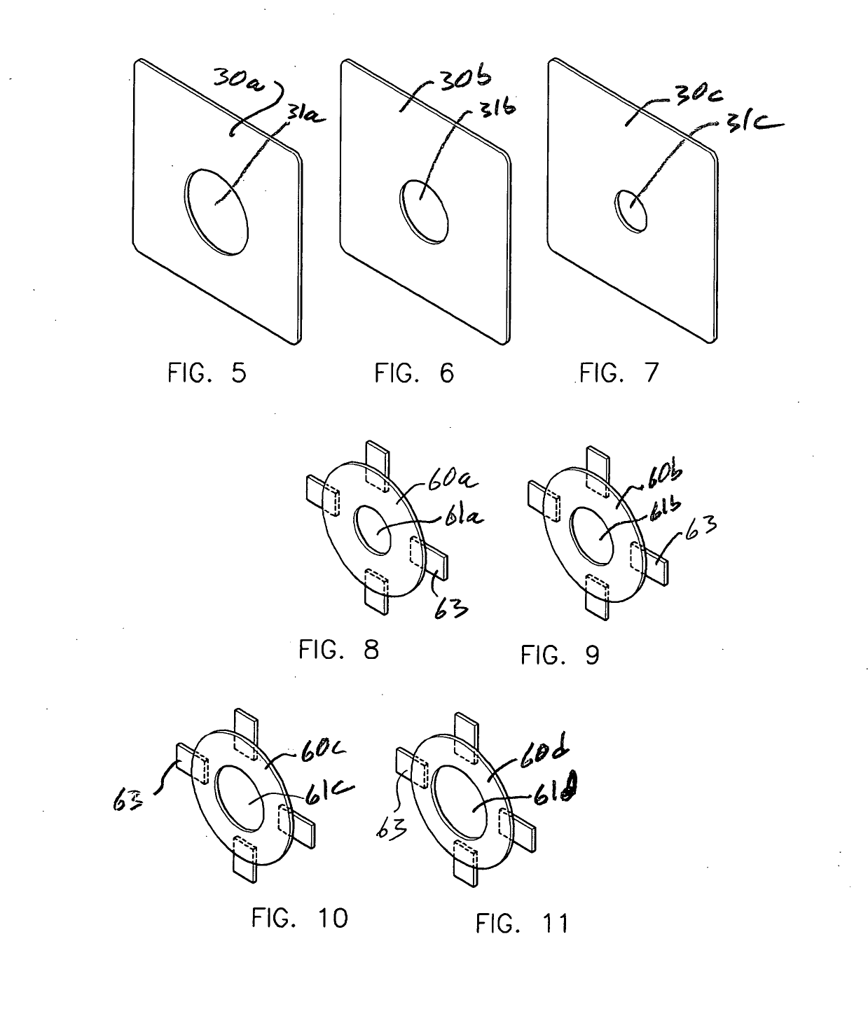

In attracting birds, often the size of the opening for the bird into the house will determine the kind of birds attracted to the house. It is thus advantageous for a user to be able to select a desired opening into the house if the user desires to attract particular kinds of birds to the house. For this purpose, the bird house can be provided with several alternative front wall shaping pieces 30, each with a different size entrance opening 31. Front wall entrance opening 21 in the collapsible shell is sized for the largest entrance opening desired for use with the bird house. For example, three alternate front wall shaping pieces, indicated in FIGS. 5-7 as 30a, 30b, and 30c, each with a different size opening 31a, 31b, and 31c, can be provided with the bird house. One piece 30a may have an opening 31a equal in size to the opening 21 through the front wall 12. Other pieces 30b and 30c may have smaller openings 31b and 31c of selected sizes. The user selects the desired opening size for the type of bird desired to be attracted to the bird house to insert into the front wall pocket. The opening 31 through shaping piece 30, when smaller than opening 21 through the front wall 12, will determine the size of the entrance opening into the bird house. The user can easily change the size of the entrance opening by merely changing the front wall shaping piece 30, i.e., by changing to piece 30a, 30b, 30c, or any additional front wall shaping piece 30 that may be available. It has been found satisfactory for use with a wide variety of birds to make the entrance opening through the front wall about two and one quarter inches in diameter and to supply front wall shaping pieces with a two and one quarter inch diameter entrance opening, a two inch diameter entrance opening, a one and three quarter inch diameter entrance opening, a one and one half inch diameter entrance opening, and a one and one quarter inch diameter entrance opening. Any number of front wall shaping pieces with different size openings may be provided.

While shaping pieces can be used for the floor, each wall, and the roof of the bird house, it has been found that a shaping piece in the floor, which establishes the shape of the floor, and shaping pieces in the front and back walls, which establish the shape of the walls of the bird house, are sufficient to shape the bird house and hold the shape during use of the bird house. The shaping pieces are made from substantially rigid or semi-rigid material so as to hold their shape but can be somewhat flexible. Sheet plastic material about one millimeter thick with rigidity similar to that used for credit cards has been found satisfactory, although various other materials can be used. Further, receiving pockets for the shaping pieces as shown for the front wall can also be used for the bottom and back walls, or any other walls, however, use of the holding straps has been found satisfactory. The pocket is currently preferred for use in the front wall to more securely hold the access opening through which the birds enter and leave the bird house in place in the front wall. In addition, while a pocket closure 28 has been shown for the front wall pocket, such a closure is not required as the pocket opening can be provided at the bottom edge of the front wall so the shell bottom, which extends at substantially a right angle to the bottom edge of the front wall will effectively close the pocket and hold the shaping piece in place in the pocket. Alternatively, the opening for the pocket could be along the top edge of the wall so that the shaping piece is held in place by the roof of the shell and by gravity, or the opening can be located along a side edge with the shaping piece held in place by the adjacent side walls which will extend at substantially right angles to close the pocket. Shaping pieces can be similarly held in pockets provided in the floor or other walls of the shell. The shaping pieces, while shown being inserted into pockets from inside the bird house or held by straps inside the bird house, could also be held in pockets opening to outside the bird house or by straps or other holding means on outside surfaces of the walls, floor, or roof of the shell. Further, rather than inserting shaping pieces into the floor and walls of the bird house, the floor and walls could contain a filling material that allows some collapsibility, but also provides enough shape to the floor or walls to make the birdhouse usable.

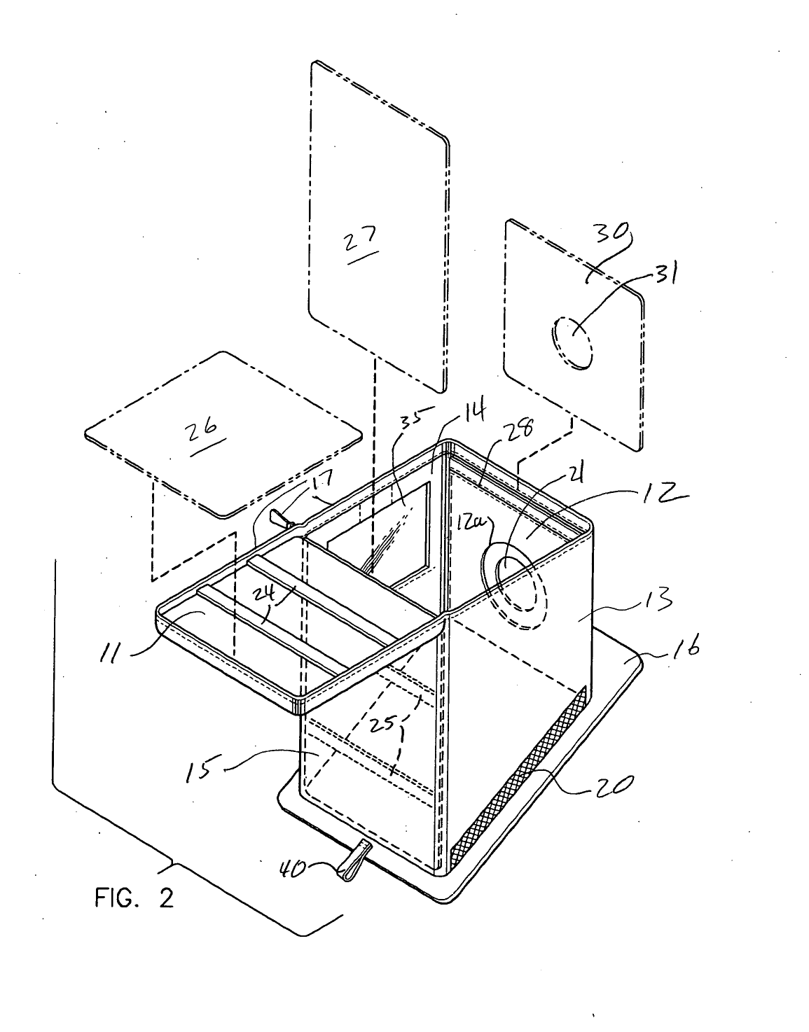

With the shaping pieces in place in the bird house shell, the bottom (if the bottom is the closable opening) is secured around all edges to the bottom of the side walls and front wall. This is done in the embodiment shown in FIGS. 1-3 by zipping the bottom 11 to side walls 14 and 15 and front wall 12. This closes the bird house and makes it ready for use. If the closable opening is provided other than as the floor, the closable opening provided is otherwise closed to make the bird house ready for use. The bird house can then be hung in a desired location. A single loop or multiple loops can be provided at various locations for use in hanging the birdhouse. Loop 40 as shown in FIGS. 1 and 2 at the top rear center of the bird house can be used for hanging the bird house on a vertical surface such as a wall or a pole or post. Loop 40 along with loop 41, FIG. 1, located at the top front center of the bird house, can be used in combination to hang the bird house from an overhead support such as a tree branch or the overhang of a roof. Various loops can be provided at other selected locations.

To enable a user to observe the birds in the bird house, one of the walls, such as side wall 13, can be provided with a window of transparent material 35, FIG. 1, with a flap 36 which is secured over the window 35 when not in use by hook and loop fastener material 37. A user can open the flap to look inside the bird house.

FIG. 4 shows a further embodiment of collapsible bird house of the invention. In the embodiment of FIG. 4, the shaping means is a substantially rigid frame 50 which is inserted into a flexible shell 52, similar to the flexible shell of the embodiment of FIGS. 1-3, through the closable opening 54 formed by closable bottom or floor 55. FIG. 4 shows the assembled frame 50 being inserted into the bird house shell through closable opening 54. The assembled frame 50 is shown made of lengths 56 of PVC pipe inserted into commercially available PVC angle connectors 57, but could be made of various materials. The frame is supplied as individual parts to be assembled by the user. Once the frame is positioned in the shell 52, floor 55 is closed by zipper 58 along the lower part of shell 52 as described for the previous embodiment. The entrance opening through front wall 59 is provided by opening forming insert 60 having an entrance opening 61 secured in front wall opening 62 by hook or loop tabs 63 that mate with loop or hook patches 64 inside the shell adjacent front wall opening 62. The entrance opening sizing is provided by alternate opening forming inserts shown as 60a, 60b, 60c, and 60d in FIGS. 8-11, with different size openings 61a, 61b, 61c, and 61d in each of the opening forming inserts.

While the bird house and collapsible shell has been shown as having a certain shape, it should be realized that the shell and bird house can be made in any desired shape to provide any desired shape bird house. The shell and bird house can also be provided in various sizes.

Whereas the invention is here illustrated and described with reference to embodiments thereof presently contemplated as the best mode of carrying out the invention in actual practice, it is to be understood that various changes may be made in adapting the invention to different embodiments without departing from the broader inventive concepts disclosed herein and comprehended by the claims that follow.

We claim:

1. A bird house, comprising:
flexible material forming a collapsible shell;
a closeable opening allowing access to inside the shell;
closure means to close the closeable opening;
shaping means insertable into the collapsible shell through the closable opening to provide structural shape to the collapsible shell; and
an entrance opening for access by birds.

2. A bird house according to claim 1, wherein the collapsible shell is configured to form a floor, walls, and a roof when provided structural shape by the shaping means.

3. A bird house according to claim 2, wherein the closeable opening extends along the lower edges of walls of the collapsible shell.

4. A bird house according to claim 2, wherein the closeable opening, when open, allows access to the floor for cleaning.

5. A bird house according to claim 2, wherein the closure means is a zipper.

6. A bird house according to claim 2, wherein the shaping means is a frame of the desired shape inserted into the shell through the closeable opening.

7. A bird house according to claim 6, wherein the frame is assembled of lengths of PVC pipe and PVC couplings.

8. A bird house according to claim 6, wherein the frame provides edges to the floor, walls, and roof of the shell.

9. A bird house according to claim 6, wherein the entrance opening for access by birds is an opening through a wall of the shell, wherein the opening through the wall of the shell is of relatively large size, and wherein the size of the entrance opening is determined by an insert having an opening therethrough of selected smaller size, said insert being placed in the opening of relatively large size through the wall and being secured to the wall adjacent the opening of relatively large size to provide an entrance opening through the insert.

10. A bird house according to claim 9, wherein the insert is secured to a wall in the opening by flaps with hook and loop fastening material.

11. A bird house according to claim 2, wherein the shaping means is a plurality of flat shaping pieces and the shell includes holding means for receiving and holding the shaping pieces.

12. A bird house according to claim 11, wherein the holding means are straps to hold a shaping piece against a wall or the floor of the bird house.

13. A bird house according to claim 12, wherein straps are provided to hold shaping pieces against the back wall and the floor of the bird house.

14. A bird house according to claim 11, wherein the holding means includes at least one receiving pocket for receiving a shaping piece therein.

15. A bird house according to claim 11, wherein the entrance opening for access by birds is an opening through a wall of the shell having a pocket and receiving a shaping piece in the pocket, and the size of the entrance opening is determined by an entrance opening through the shaping piece which aligns with the entrance opening through the wall when the shaping piece is received in the pocket.

16. A bird house according to claim 15, wherein the size of the opening is variable and the user can select the size of the opening by selecting a shaping piece having the desired size opening.

17. A bird house according to claim 2, wherein at least a portion of a wall or roof of the shell is transparent with an openable flap thereover whereby opening of the flap allows a user to see inside the shell.

18. A bird house according to claim 2, wherein the entrance opening for access by birds is an opening through a wall of the shell, wherein the opening through the wall of the shell is of relatively large size, and wherein the size of the entrance opening is determined by an insert having an opening therethrough of selected smaller size, said insert being placed in the opening of relatively large size through the wall and being secured to the wall adjacent the opening of relatively large size to provide an entrance opening through the insert.

19. A bird house according to claim 18, wherein the insert is secured to a wall in the opening by flaps with hook and loop fastening material.

20. A bird house, comprising:
flexible material forming a collapsible shell;
a closeable opening allowing access to inside the shell;
closure means to close the closeable opening;
a plurality of flat shaping pieces for providing structural shape to the collapsible shell;
holding means for receiving and holding the shaping pieces in relation to the collapsible shell so that the flat shaping pieces provide structural shape to the collapsible shell when held by the holding means; and
an entrance opening for access by birds into the collapsible shell.

21. A bird house according to claim 20, wherein the holding means are straps to hold a shaping piece against a wall or the floor of the bird house.

22. A bird house according to claim 20, wherein the holding means includes at least one receiving pocket for receiving a shaping piece therein.

23. A bird house according to claim 20, wherein the entrance opening for access by birds is an opening through a wall of the shell having a pocket and receiving a shaping piece in the pocket, and the size of the entrance opening is determined by an entrance opening through the shaping piece which aligns with the entrance opening through the wall when the shaping piece is received in the pocket.

24. A bird house according to claim 23, wherein the size of the opening is variable and the user can select the size of the opening by selecting a shaping piece having the desired size opening.
